(19) United States
(12) Patent Application Publication
(10) Pub. No.: US 2005/0198568 A1
(43) Pub. Date: Sep. 8, 2005

(54) Table display switching method, text data conversion program, and tag program

(75) Inventor: Tomohiro Matsuzaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/087,241

(22) Filed: Mar. 23, 2005

Related U.S. Application Data
(63) Continuation of application No. PCT/JP03/16018, filed on Dec. 15, 2003.

(30) Foreign Application Priority Data
Jan. 30, 2003 (JP) 2003-022668
Dec. 15, 2003 (WO) PCT/JP03/16018

(51) Int. Cl. G06F 15/16

(52) U.S. Cl. 715/513

(57) ABSTRACT

An extended tag (<uji:tableView -->) is constituted to execute a process that incorporates information (<TABLE>--</TABLE>) for displaying a block that is a part of one table and information (two <INPUT type=“submit”> tags) for displaying a “back” button and a “next” button that are input means about blocks adjacent to the current block into a text.

### TECHNICAL FIELD

The present invention relates to a table display switching method for scrolling a table on a web page, a text data conversion program that operates a computer as a device realizing the table display switching method, and a tag program that operates a computer as a device realizing the main functions of the text data conversion program.

### BACKGROUND ART

As everyone knows, when a web client machine demands a file from a web server machine according to HTTP [HyperText Transfer Protocol], the web server machine will transmit the demanded file to the web client machine and the web client machine will display a web page based on the text data in the received file.

There is technology for including a predetermined process result in the text data in the file before transmission as one of the technology developed for such a computer network system. The text data to which this technology is applied contains a program sentence (a script sentence) of a program called a script in text sentences described in markup language.

When the script sentence is not contained in the text data of the file specified by the web client machine, the web server machine transmits the text data as the web page data to the web client machine. Moreover, when the script sentence is contained in the text data of the file specified by the web client machine, the web server machine executes the script and creates web page data by describing the execution result expressed in the markup language in the description position of the script sentence, then the web server machine transmits the web page data to the web client machine.

In addition, since the script is executed by the web server machine, it is called a server side script in general. Typical server side scripts are JSP [Java Server Pages (a trademark of Sun Microsystems, Inc.)] developed by U.S. Sun Microsystems, Inc., ASP [Active Server Pages (a trademark of Microsoft Corp.)] developed by U.S. Microsoft Corp., PHP [Personal HomePage:Hypertext Processor] developed as an open source, and so on.

### PATENT DOCUMENT 1

Japanese Unexamined Patent Publication No. 237976/1999

### DISCLOSURE OF INVENTION

Incidentally, when a table that is larger than a screen (two-dimensional table that consists of some lines and some columns) is displayed on the web client machine, the above-described server side script can shows an input means in a web page to operate the table as if it is scrolled.

More specifically, the script sentence of the script for a scroll display is included in the text data in the file prepared for the web server machine.

First, the web server machine under a control of the script divides the table that is larger than a screen into some blocks each of which stays within a screen and specifies one of the blocks. Next, the web server machine creates a text sentence for displaying the specified block in a markup language, and then creates a text sentence for displaying a “back” clickable button that is clicked to switch the displayed block to the previous block and a text sentence for displaying a “next” clickable button that is clicked to switch the displayed block to the next block in the markup language. Further, the web server machine describes the created text sentences at the description positions of the script sentences in the text data in which the scripts were incorporated.

Receiving the text data created by the above described manner as web page data, the web client machine displays a block that is a part of a table with clickable buttons for switching the displayed block to the previous or next block. Moreover, when any button is clicked, the previous or next block of the displayed block is displayed with the buttons. Therefore, when the display of a block (web page) is sequentially switched by the button operation, it seems as if the table scrolls.

However, when two or more tables are shown at once in one web page, a developer has to describe several script sentences for a scroll display in the text data in a file for such a web page. Therefore, it needs time and effort to create the data for a web page for displaying many tables.

The present invention is made in view of the above-described conventional situation, and its object is to provide a table display switching method that can save the time and effort of developing the programs for the respective tables when the function that enables the scroll operation to a table will be incorporated in the text data. Moreover, the further object of the present invention is to provide a text data conversion program that operates a computer on a network as a device realizing such a table display switching method, and a tag program that operates a computer as a device realizing the main function of the text data conversion program.

A table display switching method invented in order to achieve the above-mentioned object is used in a computer network system in which a web server machine connected to a web client machine through a network creates web page data based on data in a file and transmits the web page data to the web client machine when the web server machine receives an HTTP request to specify the file from the web client machine, the method executed by the web server machine includes:
creating web page data to which information for displaying one of blocks that are obtained by dividing a table and information for displaying an input means that is used to designate acquisition of the web page data containing information about blocks adjacent to the current block are incorporated according to extended description information when the data in the file designated by the web client machine at the time of receiving the HTTP request is text data including the extended description information for displaying a table;
transmitting a HTTP response including the created web page data to the web client machine that transmitted the request;
creating a web page in which information for displaying the adjacent blocks and information for displaying the input means about the blocks adjacent to the adjacent blocks according to the designation and the extended description information when the HTTP request including the designation is received from the web client machine to which the HTTP response was transmitted; and
transmitting the HTTP response including the created web page data to the web client machine that transmitted the request.

With this construction, when the data including the extended description information is designated by the web client machine, the web server machine creates web page data according to the extended description information. The extended description information is constituted so as to execute the process to incorporate the information for displaying a block that is a part of one table and the information for displaying the input means about blocks adjacent to the current block into the text data. Therefore, a developer of the text data can easily incorporate the function to switch the displayed block that is a part of one table by using the extended description information. Thus, a developer can easily create text data about one web page that shows two or more tables at once by incorporating many sets of the extended description information into the text data.

Further, a text data conversion program invented in order to achieve the above-mentioned object runs on a computer connected to a web client machine through a network, said program includes:
waiting until a HTTP request is transmitted from the web client machine;
determining whether the data in the file designated by the web client machine is text data including extended description information for displaying one table when the HTTP request is received;
incorporating information for displaying one of blocks that are obtained by dividing the table and information for displaying an input means that is used to designate acquisition of the text data containing information about blocks adjacent to the current block into the text data according to the extended description information when the data is text data including the extended description information;
transmitting a HTTP response whose body contains the text data incorporating the respective sets of information as web page data to the web client machine that transmitted the request;
waiting until a HTTP request containing the designation is transmitted from the web client machine to which the HTTP response was transmitted;
incorporating information for displaying the adjacent blocks and information for displaying the input means about blocks adjacent to the adjacent blocks according to the designation and the extended description information into the text data when the HTTP request is received; and
transmitting a HTTP response whose body contains the text data incorporating the respective sets of information as web page data to the client machine that transmitted the request.

Therefore, the text data conversion program can operate a computer on a network as a device realizing the above-described table display switching method of the present invention.

Further, a tag program invented in order to achieve the above-mentioned object runs on a computer connected to a recording device that stores text data consists of many tags as a base of web page data and data to be described in a table on the web page, the program outputs the information for displaying one of blocks that are obtained by dividing the table and the information for displaying an input means that is used to designate acquisition of the web page data containing information about blocks adjacent to the current block to the text data, when the specified tag as the extended description information is read during the respective tags in the text data are sequentially read.

Therefore, this tag program can operate a computer as a device realizing the main functions of the text data conversion program.

As described above, the present invention can save the time and effort of developing the programs for the respective tables when the function that enables the scroll operation to a table will be incorporated in the text data.

### BRIEF DESCRIPTION OF DRAWINGS

FIG. 1 is a block diagram showing the whole computer network system to which the invention is applied.

FIG. 2 is a block diagram showing insides of a web client machine and a web server machine, respectively.

FIG. 3 is a figure showing an example of the data structure of an operation table.

FIG. 4 is a figure showing an example of the data structure of a list table.

FIG. 5 is a figure showing an example of the text data containing scripts related to the present invention.

FIG. 6 is a flow chart showing contents of a web server process.

FIG. 7 is a flow chart showing contents of a dispatch process.

FIG. 8 is a flow chart showing contents of an updater process.

FIG. 9 is a flow chart showing a web page data generation process.

FIG. 10 is a flow chart showing contents of a web page data generation process.

FIG. 11 is a figure showing an example of the program generated by executing a tag program.

FIG. 12 is a flow chart showing contents of an input reception process.

FIG. 13 is a table explaining types of request parameters.

FIG. 14 is a figure showing an example of the table displayed on a web client machine before and after the click of a “back” button or a “next” button.

### BEST MODE FOR CARRYING OUT THE INVENTION

Hereafter, an embodiment of the present invention will be described based on drawings.

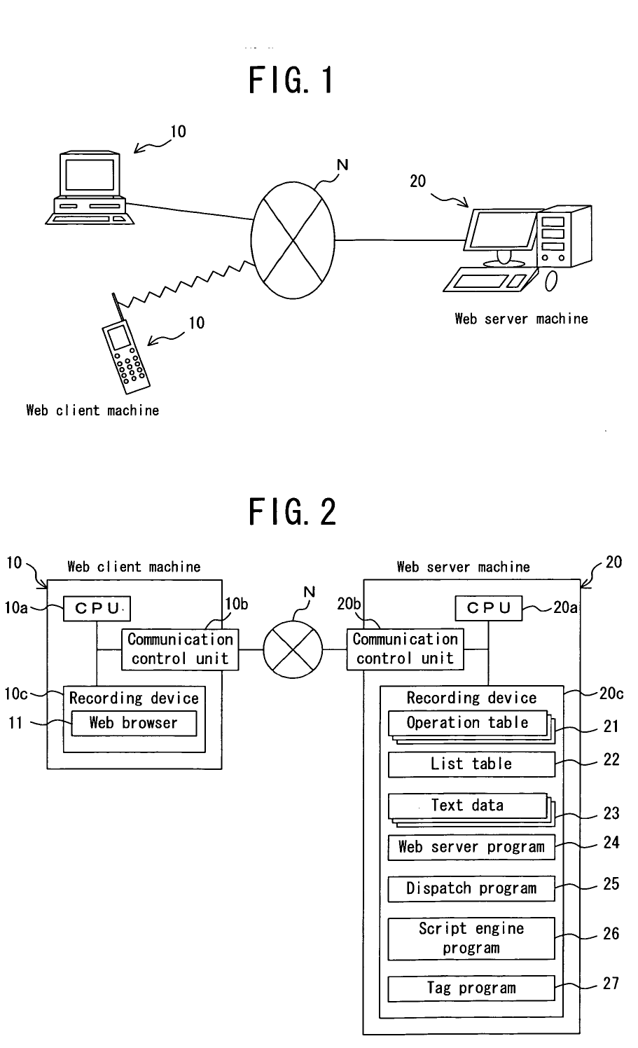

FIG. 1 is a block diagram showing the whole computer network system to which the present invention is applied. The computer network system is equipped with a web client machine 10 and a web server machine 20. These machines 10 and 20 are mutually connected through the Internet N.

FIG. 2 is a block diagram showing insides of the web client machine 10 and the web server machine 20, respectively. The web client machine 10 is equipped with a CPU [Central Process Unit] 10a, a communication control unit 10b, and a recording device 10c.

The CPU 10a is a central process unit that controls the web client machine 10 as a whole. The communication control unit 10b is a device for transmitting/receiving data to/from a router that constitutes the Internet N through cable or radio. Specifically, it is a LAN [Local Area Network] connection board, a terminal adapter, a modem, a radio frequency circuit, or the like.

The recording device 10c is a random access memory, a hard disk drive, a flash memory, or the like. An operating system program for managing hardware and software synthetically, and various kinds of data and programs are stored in the recording device 10c. A web browser 11 is contained in the programs stored in the recording device 10c.

The web browser 11 is a program that acquires web page data, image data, or the like from the website on the Internet N and displaying a web page, an image, or the like on a display. Accepting an input operation by an operator, the CPU 10a that executed the web browser 11 creates a HTTP request containing URL [Uniform Resource Locator] specified by the operator according to HTTP [Hyper Text Transfer Protocol], and then, transmits the HTTP request to the web server machine 20 indicated by the domain name in the URL. Further, when the CPU 10a receives a HTTP response in response to the HTTP request during the execution of the web browser 11, the CPU 10a displays the web browser screen that includes web pages and images based on the data in the body of the HTTP response.

The web server machine 20 is equipped with a CPU 20a, a communication control unit 20b, and a recording device 20c. The CPU 20a, the communication control unit 20b, and the recording device 20c have functions equivalent to those of the web client machine 10. The recording device 20c of the web server machine 20 stores an operating system program for managing hardware and software synthetically, and various kinds of data and programs.

Many operation tables 21, a list table 22, and much text data 23 are contained in the data stored in the recording device 20c. Further, a web server program 24, a dispatch program 25, a script engine program 26, and a tag program 27 are included in the programs stored in the recording device 20c.

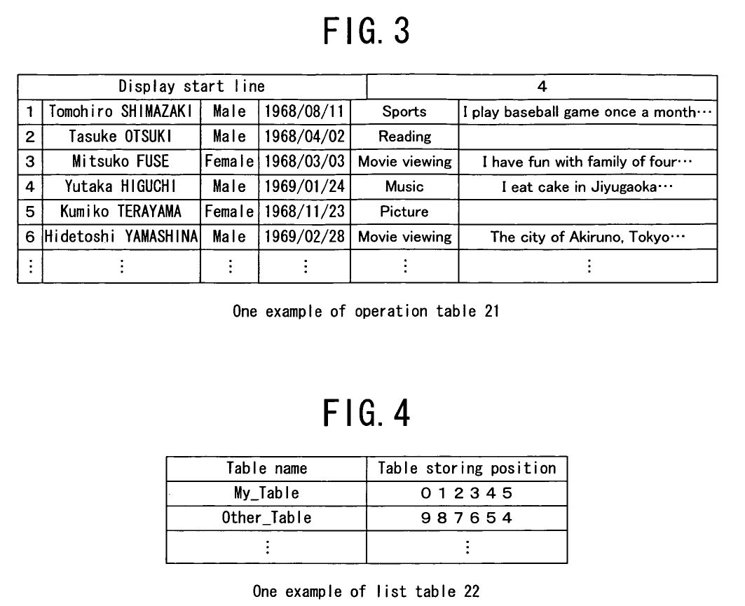

The operation table 21 is used to manage user information, for example, by a trader who renders a service using the web server machine 20. FIG. 3 is a figure showing an example of the data structure of the operation table 21 for managing user information. The operation table 21 of FIG. 3 has records as many as customers. Each record has fields of a “member number”, a “name”, “sex”, a “birth date”, a “hobby”, and a “profile”.

The “member number” field stores a member number that is an identification number to discriminate a user among many users by the above-mentioned trader. User's name, sex, birth date, and hobby are recorded in the fields of “name”, “sex”, “birth date”, and “hobby”. A user's own comment, for example, is recorded in the “profile” field. If a user has no comment, the “profile” field becomes blank.

Incidentally, the operation table 21 of FIG. 3 has a “display start line” field as well as the above-mentioned six fields. A display start line number is recorded in the “display start line” field. The display start line number is used to designate any one block when many records stored in the operation table 21 are divided into several blocks. Specifically, the display start line number is a line number of a head record of a block in all the records. For example, assuming that the line numbers, which are natural numbers, are assigned to all the records in the operation table 21 and all the records are divided into the blocks each of which contains three records, the display start line number of the second block is “4”. In addition, the display start line number in the “display start line” field may be increased or decreased when the below-mentioned dispatch program 25 rewrites the number into a different value.

The list table 22 works to manage many operation tables 21 as a single unit. FIG. 4 is a figure showing an example of the data structure of the list table 22. The number of the records in the list table 22 of FIG. 4 is equal to the number of the operation tables 21. Each record has fields of a “table name” and a “table storing position”.

The name of the operation table 21 is recorded in the “table name” field. The record position of the operation table 21 in the recording device 20c is recorded in the “table storing position” field.

The text data 23 is used to supply a web page containing predetermined contents to the web client machine 10. Specifically, the text data 23 includes texts described in the markup language only, or texts described in the markup language with program sentences (script sentences) described in the script language.

The above-mentioned markup language is HTML [HyperText Mark-up Language], XML [eXtesible Mark-up Language], XHTML [eXtesible HyperText Mark-up Language], compact HTML, MML[Mobile Mark-up Language], HDML [Hand-held Device Mark-up Language], or the like.

Further, the above-mentioned script language is Java (a trademark of Sun Microsystems, Inc.) language, VBScript (a trademark of U.S. Microsoft Corp.) language, Java Script (a trademark of Sun Microsystems, Inc. and Netscape Communications) language, PHP [Personal HomePage:Hypertext Processor] language, or the like.

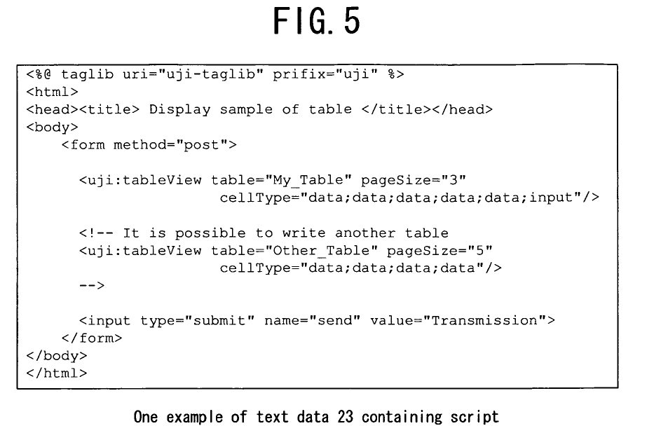

In addition, since the present invention uses the text data 23 containing the script sentence, the recording device 20c stores at least one text data 23 containing the script. FIG. 5 is a figure showing an example of the text data 23 containing the script according to the present invention.

The text data 23 of FIG. 5 has the text (<html>-- </html>) described in HTML. Further, the tag (<% @taglib uri=“uji-taglib” prefix=“uji” %>) that declares use of the extended tag according to the JSP [Java Server Pages (a trademark of Sun Microsystems, Inc.)] technology is inserted in front of the text described in HTML. Still further, the so-called extended tag (<uji:tableView -- >) that is extended description information is used in the text described in HTML.

Incidentally, the recording device 20c may store data to output images, sounds, and videos that constitute the contents of the web page as well as the text data 23. In this case, URL that defines each data is described in the above-mentioned text data 23.

The web server program 24 creates a website on the Internet N to transmit web page data, image data, or the like in response to the request from the web browser 11. Receiving a HTTP request from the web client machine 10, the CPU 20a that executes the web server program 24 determines whether a function of another program should be called or not based on URL in the HTTP request. If the function is not called, the CPU 20a transmits the data in the file designated by the URL as a HTTP response to the web client machine 10. If the function is called, the CPU 20a calls and executes the function, and then transmits the processed data as the HTTP response to the web client machine 10.

In addition, the web server program 24 has a function to set up a correspondence relation between the URL in the HTTP request and the function called corresponding to the URL. A developer of each application (website application) recorded on the web server machine 20 sets up the correspondence relation between the URL and the function in advance. In the embodiment, it is set up so that the URL of the text data 23 described in the markup language only calls no function but the URL of the text data 23 containing the script as shown in FIG. 5 calls the function by the dispatch program 25.

Accepting a process request from the function of the web server program 24, the dispatch program 25 makes the CPU 20a select the function to perform suitable process according to the contents of the request and call the selected function. Although the dispatch program 25 can call many functions in fact, only the script engine program 26 relevant to the present invention will be described in detail in the following description.

Accepting a process request from the function of the dispatch program 25, the script engine program 26 makes the CPU 20a read the text data 23 in the file shown by URL in the HTTP request and execute the script that is contained in the text data 23. When the program 26 is executed, the tags in the script sentence are interpreted one by one by the CPU 20a, and a process corresponding to the tag is executed every time a tag is read. Therefore, the script contained to the text data 23 mentioned above is a server side script.

The script engine program 26 must be a program corresponding to the language of the script contained in the text data 23. Specifically, the script engine program 26 is a JSP [Java Server Pages (a trademark of Sun Microsystems, Inc.)] engine program when the script language is Java language, an ASP [Active Server Pages (a trademark of Microsoft Corp.)] engine program when the script language is VBScript language or Java Script language, or a PHP engine program when the script language is PHP language.

The tag program 27 is a program (tag handler) corresponding to an extended tag. The tag program 27 is called by the function of the script engine program 26 and is executed only when the CPU 20a reads the extended tag in the script contained in the text data 23.

Hereinafter, the processes executed in the computer network system constituted as mentioned above will be described.

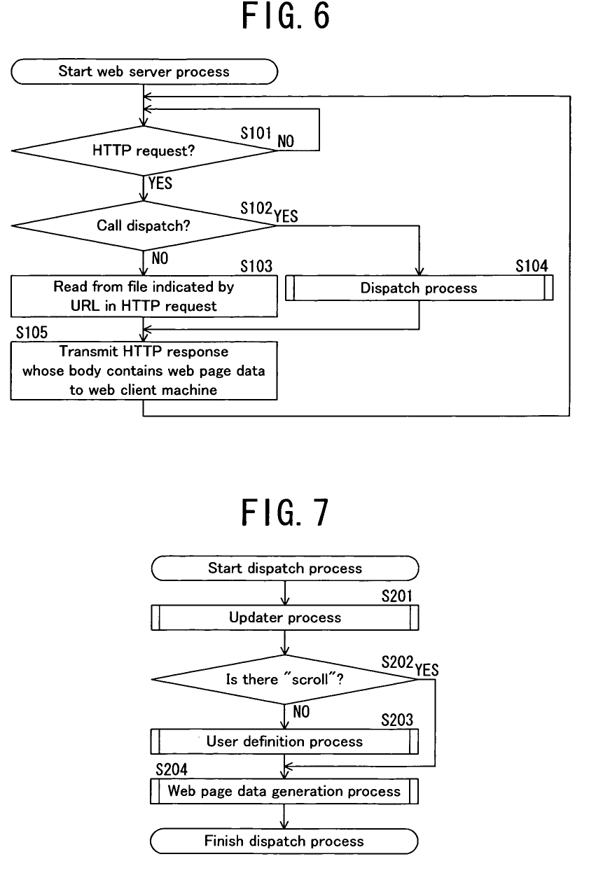

First, the CPU 20a of the web server machine 20 reads the web server program 24, the dispatch program 25, and the script engine program 26. Then, these programs are resident. FIG. 6 is a flowchart showing the contents of the web server process executed by the function of the web server program 24.

At the first step SI 01 after the web server process starts, the CPU 20a stands by until a HTTP request is transmitted from any web client machine 10 (S101; NO).

When a user of the web client machine 10 operates the machine 10 to start the web browser 11 and inputs URL containing a domain name of the web server machine 20, the web client machine 10 transmits a HTTP request to the web server machine 20.

Receiving the HTTP request from any web client machine 10 (S101; YES), the CPU 20a of the web server machine 20 advances the process to step S102.

At step S 102, the CPU 20a determines whether the URL in the HTTP request must call the function of the dispatch program 25 or not. If the URL in the HTTP request does not require calling the function of the dispatch program 25 (S102; NO), that is, if the extension is “html” or “jpeg”, for example, the CPU 20a advances the process to step S103.

At step S103, the CPU 20a reads data from the file indicated by the URL in the HTTP request, and advances the process to step S105.

On the other hand, if the URL in the HTTP request requires calling the function of the dispatch program 25 (S102; YES), that is, if the extension is “jsp”, for example, the CPU 20a advances the process to step S104.

At step S104, the CPU 20a calls the function of the dispatch program 25 to execute the dispatch process. FIG. 7 is a flowchart showing the contents of the dispatch process.

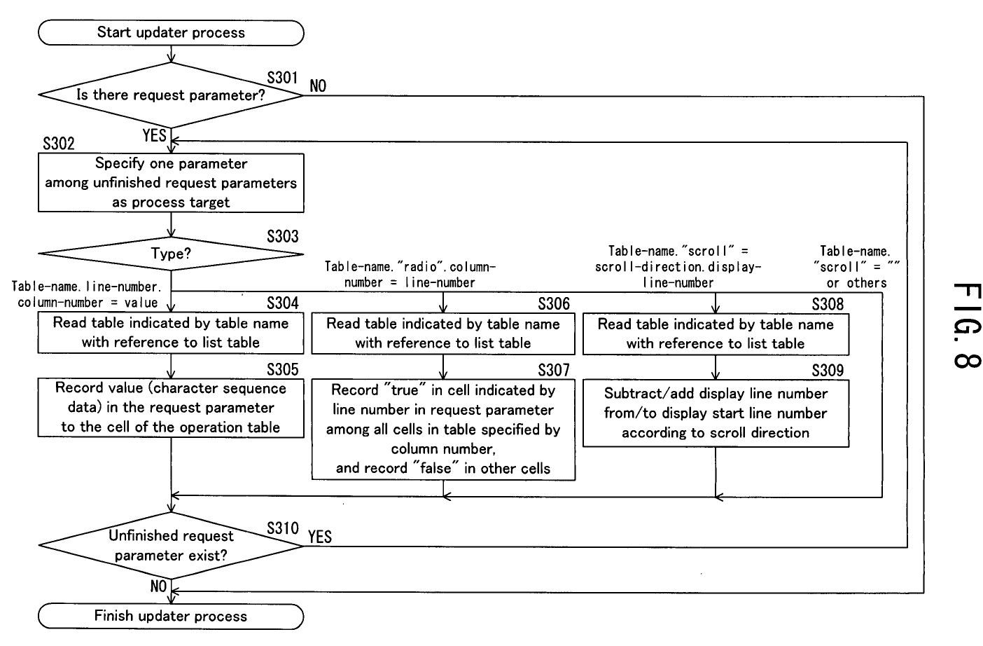

At the first step S201 after the dispatch process starts, the CPU 20a calls the function of the updater program. In addition, the function of the updater program is one of the functions that can be called by the dispatch program 25. Then, the CPU 20a calls the function of the updater program and makes the function execute the updater process. FIG. 8 is a flowchart showing the contents of the updater process.

At the first step S301 after the updater process starts, the CPU 20a determines whether the request parameter was received with the HTTP request at step S101 or not.

The request parameter is information transmitted to the web server machine 20 with a HTTP request through a GET method or a POST method by a “form” function that is one of internal contents of the web page, when any operation is input in the web page displayed in the web browser screen.

More specifically, the request parameter reflects the value of a “name” attribute and the value of a “value” attribute that are described in the <INPUT> tag in the web page data transmitted to the web client machine 10. The request parameter is transmitted to the web server machine 20 from the web client machine 10 in the form of a ““name” attribute value=“value” attribute value”.

When the request parameter was not received with the HTTP request at step S301, the CPU 20a finishes the updater process and advances the process to step S202 in the dispatch process shown in FIG. 7.

On the other hand, when the request parameter was received with the HTTP request at step S301, the CPU 20a executes process from S302 to S310. The process from S302 to S310 is described later for the purpose of easy understanding. The CPU 20a finishes the updater process after execution of the process from S302 to S310, and advances the process to step S202 in the dispatch process of FIG. 7.

At step S202, the CPU 20a determines whether the request parameter that has the character sequence “scroll” as the “name” attribute value exists or not. When the request parameter exists (S202; YES), the CPU 20a advances the process to step S204. When the request parameter that has the character sequence “scroll” as the “name” attribute value does not exist (S202; NO), the CPU 20a advances the process to step S203.

At step S203, the CPU 20a calls the function of the user definition program, and makes the function execute a user definition process. The function of the user definition program is one of the functions that can be called by the function of the dispatch program 25. Then, calling the function of the user definition program, the CPU 20a makes the function execute the user definition process.

However, since the user definition program is not directly related to the present invention, only its outline will be described briefly. The user definition program is created by the above mentioned developer of the web application. For example, assuming that a web application is an order-received application in a shopping site, a user definition program executes the CPU 20a record the information into an order-received check database at the time when the web server machine 20 receives the information inputted into the order check screen displayed on the web client machine 10 as a request parameter. In addition, web application developers generally create such a user definition program.

In this embodiment, at step S203, the function of the user definition program, which was created by the developer of the web application in advance, reads a record from the operation table 21, additionally stores a record to the operation table 21, or overwrites a record in the operation table 21 to update for the purpose of accumulation of member-information or check-information and edition of data, for example. Since the information inputted into the text box in the table (see FIG. 14) displayed on the web client machine 10 will be updated by overwriting the operation table 21 in the below-mentioned updater process, the function of the user definition program executed at step S203 can acquire the information inputted into the text box in the table displayed on the web client machine 10. The CPU 20a advances the process to step S204, after calling and executing the function by such a user definition program.

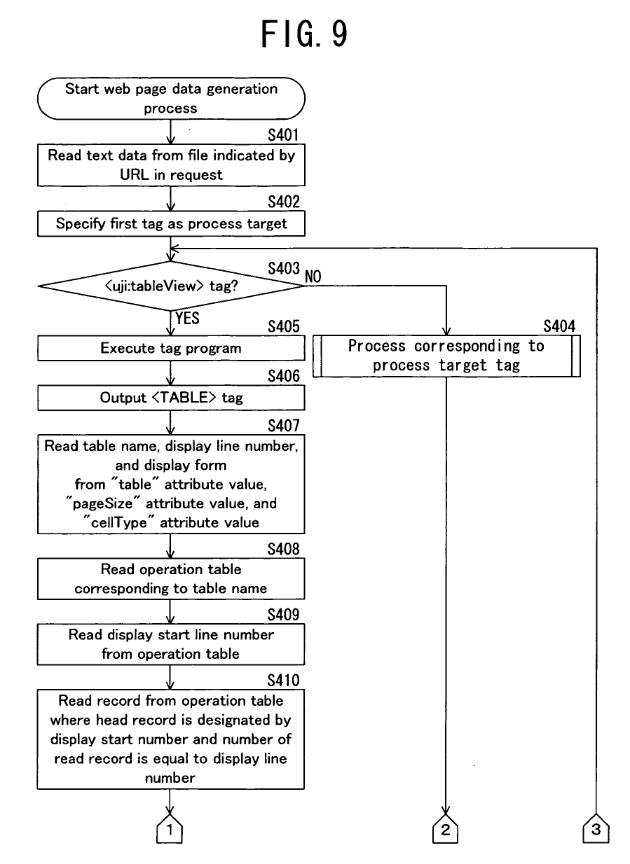

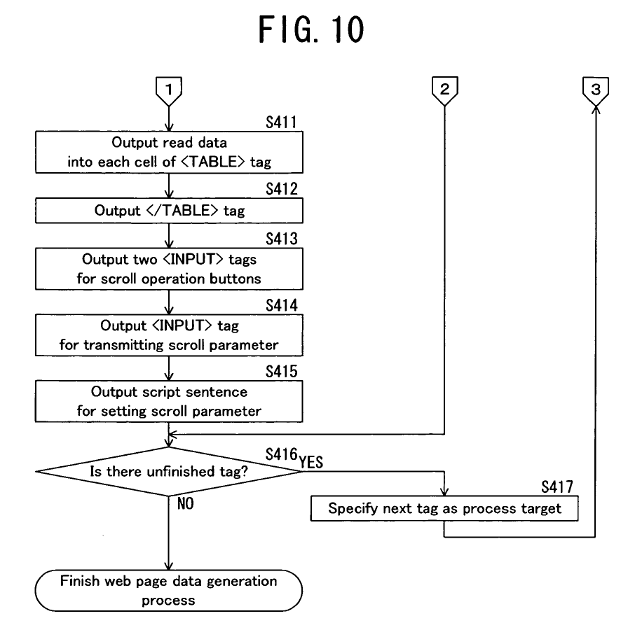

At step S204, the CPU 20a calls the function of the script engine program 26, and makes the function execute a web page data generation process. FIG. 9 and FIG. 10 are flow charts showing the contents of the web page data generation process.

At the first step S401 after the web page data generation process starts, the CPU 20a reads the text data 23 from the file indicated by the URL in the HTTP request. In addition, the text data 23 read at step S401 contains the script sentence as with the text data 23 shown in FIG. 5.

At the next step S402, the CPU 20a specifies the first tag in the read text data 23 as a process target.

At the next step S403, the CPU 20a determines whether the process target tag is the <uji:tableView> tag that defines an extended tag or not. When the process target tag is not the <uji:tableView> tag (S403; NO), the CPU 20a advances the process to step S404.

At step S404, the CPU 20a executes the process corresponding to the process target tag. For example, if the process target tag is a HTML tag, the CPU 20a does nothing. If the process target tag is a script tag, the CPU 20a executes the tag program corresponding to the script tag. Then, the CPU 20a advances the process to step S416 after execution of step S404.

On the other hand, if the process target tag is the <uji:tableView> tag (S403; YES), the CPU 20a advances the process to step S405.

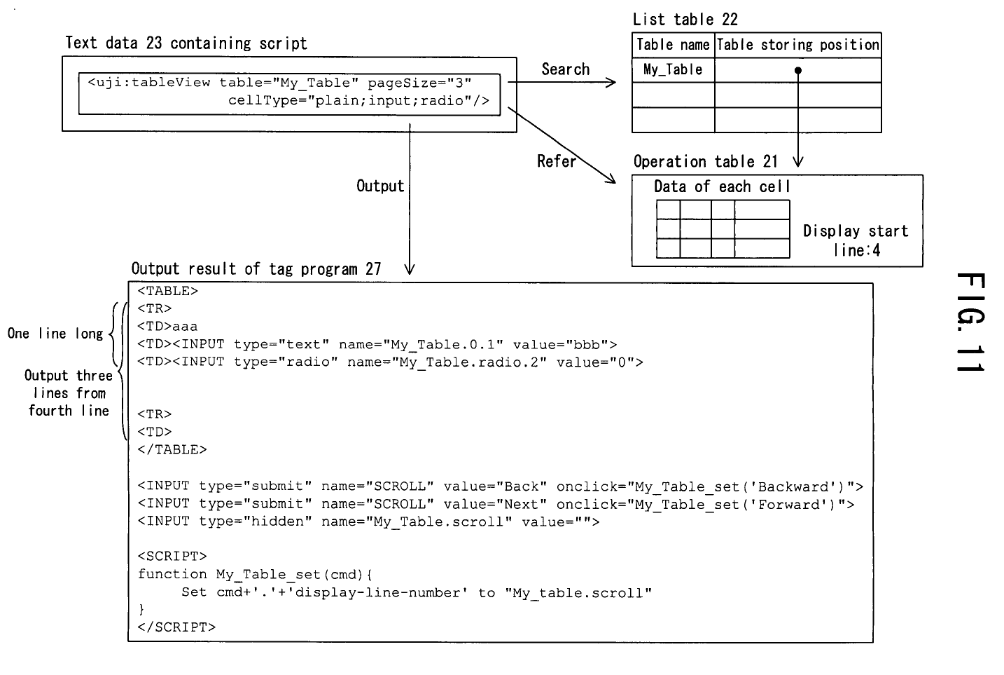

At step S405, the CPU 20a reads and executes the tag program 27 corresponding to “tableView” in the <uji:tableView> tag through the “taglib” directive that has “uji” in <uji:tableView> tag as a “prefix” attribute value. The process of steps from S406 to S415 is executed by the tag program 27. In addition, FIG. 11 shows an example of the program used for describing the process in steps from S406 to S415.

At the next step S406, the CPU 20a deletes the <uji:tableView> process target tag in the script contained in the text data 23 read at step S401, and outputs (describes) the <TABLE> tag at the describing position of the <uji:tableView> tag.

At the next step S407, the CPU 20a reads a “table” attribute value, a “pageSize” attribute value, and a “cellType” attribute value in the <uji:tableView> process target tag, as a table name, a display line number, and a display form, respectively.

In addition, the table name designates the operation table 21 in which the data described in the table (see FIG. 14) displayed on a web page is stored. Moreover, the display line number is a value that specifies the display line number in the whole table displayed on a web page.

Further, the display form specifies a number of cells contained in one line of the table displayed on a web page, and the contents indicated in each cell. For example, if the parameter is “data; data; data”, three pieces of the data read from the operation table 21 are displayed in three cells on one line in the above-mentioned table. Moreover, if the parameter is “data; data; input; radio”, two pieces of the data read from the operation table 21, a text box, and a radio button are displayed in four cells on one line in the above-mentioned table.

At the next step S408, the CPU 20a reads the operation table 21 corresponding to the table name with reference to the list table 22.

At the next step S409, the CPU 20a reads a display start line number from the operation table 21 that was read.

At the next step S410, the CPU 20a reads the records from the operation table 21. The head record is designated by the display start number read at step S409, and the number of the read record is equal to the display line number read at step S407. In addition, the number of fields in each record read here is the same as the number of data specified in the above-mentioned display form.

At the next step S411, the CPU 20a outputs (describes) the data read from each record at S410 behind the <TABLE> tag. Specifically, the CPU 20a outputs (describes) the information about the contents in all the cells using a <TR> tag that specifies the position of each line of the two-dimensional table displayed on a web page and a <TD> tag that specifies the contents in each cell. In addition, when the data read from the operation table 21 becomes the contents in the cells, the data is described as it is behind the <TD> tag. Further, when a text box or a radio button becomes the content in a cell, the <INPUT> tag whose type attributes is “text” or “radio” is described behind the <TD> tag.

At the next step S412, the CPU 20a outputs (describes) a </TABLE> tag behind the <TD> tag outputted at step S411.

At the next step S413, the CPU 20a outputs (describes) two <INPUT> tags behind the </TABLE> tag. These two <INPUT> tags are for displaying a scroll operation button on a web page, and the character sequence “submit” is set to those “type” attributes.

In addition, at the step S413, the CPU 20a assigns the character sequence “back” for the “value” attribute and assigns the character sequence “My_Table_set (‘Backward’)”, which is defined later as a method of the Java Script function that is the sub routine executed by the web client machine 10, for the “onclick” attribute of one <INPUT> tag, respectively. Further, the CPU 20a assigns the character sequence “next” for the “value” attribute and assigns the character sequence “My_Table_set (‘Forward’)”, which is defined later as a method of the Java Script function, for the “onclick” attribute of the other <INPUT> tag, respectively. Still further, the CPU 20a assigns the character sequence “SCROLL” for the “name” attribute of both of the <INPUT> tags.

At the next step S414, the CPU 20a outputs (describes) one <INPUT> tag behind the two <INPUT> tags that were outputted at S413. The <INPUT> tag is for setting up the parameter used for scroll operation, and the character sequence “hidden” is set to the “type” attribute. In addition, at the step S414, the CPU 20a assigns the character sequence “My_Table.scroll” for the “name” attribute and assigns “ ” (blank) for the “value” attribute of the <INPUT> tag.

At the next step S415, the CPU 20a outputs (describes) a script sentence behind the <INPUT> tag outputted at step S414. The script sentence is for setting the character sequence ‘Forward’ or ‘Backward’ to define the scroll direction to the “value” attribute of the <INPUT> tag outputted at step S414. Specifically, the CPU 20a outputs (describes) the <SCRIPT> tag first, and then describes function “My_Table_set (cmd) [--]” that is a Java Script function behind the <SCRIPT> tag. Although the comment is described in “[ ]” of the Java Script function in FIG. 11, a program will be described in fact. Then, the CPU 20a outputs (describes) a </SCRIPT> tag behind the script function.

At the next step S416, the CPU 20a determines whether an unfinished tag exists in the text data 23 read at step S401 or not. When an unfinished tag exists (S416; YES), the CPU 20a advances the process to step S417.

At step S417, the CPU 20a specifies the next tag as a process target among unfinished tags, and returns the process to step S403.

If all the tags have been processed while executing the process loop from S403 to S417 (S416; NO), the CPU 20a branches the process from step S416, and finishes the web page data generation process. Then, the CPU 20a finishes the dispatch process of FIG. 7, and advances the process to step S105 in the web server process of FIG. 6.

At step S105, the CPU 20a transmits the HTTP response whose body contains the data read at step S103 or the data generated at step S104 (step S204) to the web client machine 10 that has transmitted the HTTP request. Then, the CPU 20a returns the process to step S101 and waits until the next HTTP request is transmitted from any web client machine 10.

Since the web server machine 20 executes the above mentioned web server process, the web server machine 20 creates the text data by replacing the portion of the <uji:tableView> tag in the text data 23 as shown in FIG. 5 with the text as shown in FIG. 11, and the created text data is transmitted to the web client machine 10 as the web page data.

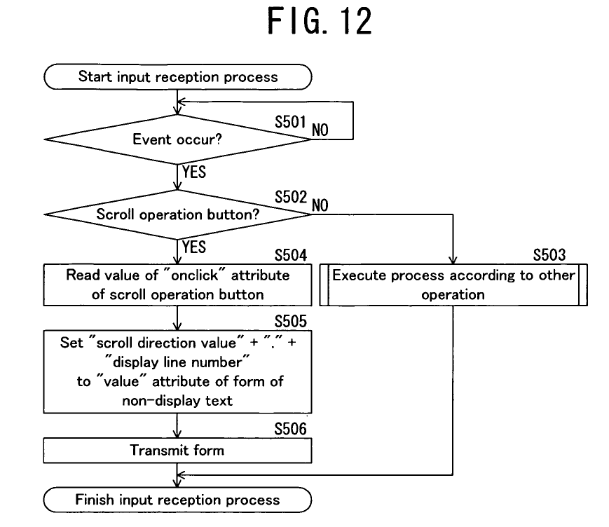

In the web client machine 10 that received the HTTP response whose body contains such web page data, the web browser 11 makes CPU 10a display a web page based on the web page data. And then, the web client machine 10 starts an input reception process after the web browser 11 displays the web page. FIG. 12 is a flowchart showing the contents of the input reception process.

At the first step S501 after the input reception process starts, the CPU 10a waits until an event such as a click of a button occurs (S501; NO). When an event occurs (S501; YES), the CPU 10a advances the process to step S502.

At step S502, the CPU 10a determines whether the event is a click of the scroll operation button or not. If the event is not a click of the scroll operation button (S502; NO), the CPU 10a advances the process to step S503.

At step S503, the CPU 10a executes a process according to the event detected at step S501. For example, when the event is a press of an enter key after URL was inputted into the text box for inputting a URL on the web browser screen, the CPU 10a creates the HTTP request containing the URL, and transmits the HTTP request to the web server machine 20 indicated by the domain name in the URL. Then, the CPU 10a finishes the input reception process after execution of such a process.

On the other hand, if the event is a click of the scroll operation button (S502; YES), the CPU 10a advances the process to step S504.

At step S504, the CPU 10a reads the value of the “onclick” attribute of the <INPUT> tag related to the clicked scroll operation button. In addition, the value read here is a character sequence that specifies the method of the Java Script function as shown in FIG. 11.

At the next step S505, the CPU 10a executes the script corresponding to the character sequence read at step S504. The script executed here is a script described behind three <INPUT> tags, as shown in FIG. 11. Specifically, the CPU 10a sets “scroll-direction (character sequence ‘Forward’ or ‘Backward’)+dot (.)+display-line-number” to the “value” attribute of the third <INPUT> tag that is a form of a non-display text. In addition, when the “back” scroll operation button was clicked, the scroll direction set here is ‘Backward’, when the “next” scroll operation button was clicked, the scroll direction set here is ‘Forward’.

At the next step S506, the CPU 10a reads the value of the “name” attribute (“My_Table.SCROLL”) and the value of the “value” attribute (‘Forward’ or ‘Backward’+.+display-line-number) of the third <INPUT> tag, and transmits the parameter “My_Table.SCROLL=‘Forward’ or ‘Backward’.display-line-number” with the HTTP request to the web server machine 20 through the GET method or the POST method. The URL contained in the HTTP request is the same as the URL of the text data 23 shown in FIG. 5. Then, the CPU 10a finishes the input reception process after transmission of the HTTP request.

Since the above mentioned input reception process is executed, a request parameter is transmitted to the web server machine 20 when the “back” button or the “next” button on the web page (see FIG. 14) is clicked.

On the other hand, receiving the HTTP request containing such a request parameter (step S101 of FIG. 6), the CPU 20a of the web server machine 20 determines that the URL in the HTTP request must call the function by the dispatch program 25 (step S102 of FIG. 6; YES), and starts the updater process of FIG. 8 (step S104 of FIG. 6, and step S201 of FIG. 7). Then, the CPU 20a determines that the HTTP request includes a request parameter (step S301 of FIG. 8; YES), and advances the process to step S302. Hereafter, the process from step S302 to step S310, which was postponed, in the updater process will be described.

At step S302, the CPU 20a specifies the first parameter among the request parameters transmitted with the HTTP request as a process target.

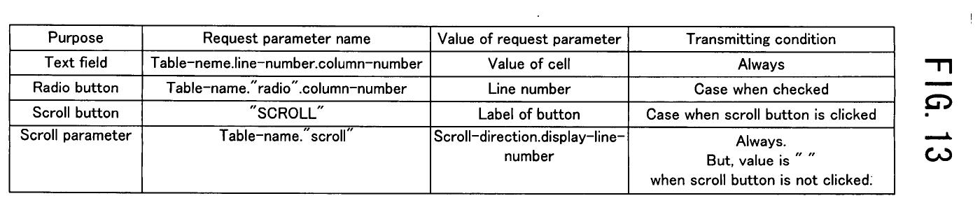

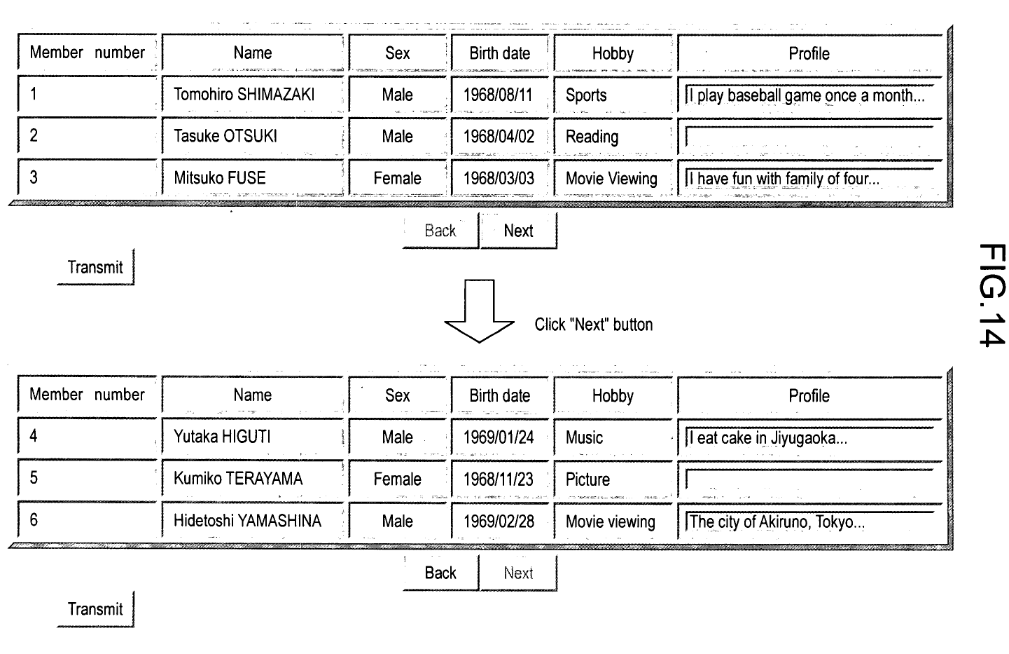

At the next step S303, the CPU 20a determines the type of the request parameter of the process target. In addition, FIG. 13 is a table for explaining the types of the request parameters.

As shown in FIG. 13, when the request parameter is “table-name.line-number. column-number=value”, this request parameter is for transmitting the character sequence data inputted into the text box of the table on the web page (see FIG. 14) to the web server machine 20. Further, when the request parameter is “table-name.“radio”. column-number=line-number”, this request parameter is for transmitting the line number of the turn-on radio button in the table on a web page to the web server machine 20.

Further, when the request parameter is ““scroll”=“back” or “next””, the request parameter informs the web server machine 20 that the scroll operation button was clicked. Still further, when the request parameter is “table-name. “scroll”=‘Forward’ or ‘Backward’.display-line-number”, the request parameter transmits the scroll direction and the scroll line number to the web server machine 20.

At the step S303, the CPU 20a advances the process to step S304 when the request parameter is “table-name.line-number.column-number=value” (S303; table-name.line-number.column-number=value), to step S306 when the request parameter is “table-name.“radio”.column-number=line-number” (S303; table-name.“radio”.column-number=line number), to step S308 when the request parameter is “table-name.“scroll”=‘Forward’ or ‘Backward’.display-line-number” (S303; table-name.“scroll”=scroll-direction.display-line-number), or to step S310 when the request parameter is “table-name.“scroll”=“ ”” or others (S303; table-name.“scroll”=“ ” or others).

At step S304, the CPU 20a reads the operation table 21 corresponding to the file name in the request parameter with reference to the list table 22.

At the next step S305, the CPU 20a records the value (character sequence data) in the request parameter to the cell of the operation table 21 indicated by the line number and the column number in the request parameter, and advances the process to step S310.

Further, at step S306, the CPU 20a reads the operation table 21 corresponding to the file name in the request parameter with reference to the list table 22.

At the next step S307, the CPU 20a records “true” in the cell indicated by the line number in the request parameter among all the cells in the field of the operation table 21 specified by the column number in the request parameter, records “false” in the other cells, and advances the process to step S310.

Further, at step S308, the CPU 20a reads the operation table 21 corresponding to the file name in the request parameter with reference to the list table 22.

At the next step S309, the CPU 20a reads a display start line number from the operation table 21 and subtracts/adds the display line number in the request parameter from/to the display start line number. The CPU 20a adds the display line number to the display start line number when the scroll direction in the request parameter is ‘Forward’, and it subtracts the display line number from the display start line number when the scroll direction in the request parameter is ‘Backward’. Then, the CPU 20a records the display start line number after subtraction or addition to the operation table 21 and advances the process to step S310.

At step S310, the CPU 20a determines whether an unfinished request parameter exists or not. Then, the CPU 20a returns the process to step S302 to specify a next process target request parameter when an unfinished request parameter exists (S310; YES). When an unfinished request parameter does not exist (S310; NO), the CPU 20a finishes the updater process.

Since such an updater process is executed on the web server machine 20 and the web page data created based on the text data 23 containing the script is constituted by replacing the portion of the extended tag of the script content text data 23 of FIG. 5 with the text of FIG. 11, there are the following actions according to the computer network system of the embodiment.

That is, when the web page created based on the text data 23 shown in FIG. 5 is displayed on the web client machine 10 and the “back” button or the “next” button on the web page is clicked, the HTTP request containing the URL of the text data 23 of FIG. 5 will be transmitted to the web server machine 20. At the same time, the request parameter that shows the scroll direction and the display line number is transmitted with the HTTP request, and the web page data for displaying a table whose contents are adjacent to the contents of the table on the web page that has been already displayed on the web client machine 10 is created based on the request parameter. Then, the web page data is transmitted to the web client machine 10 as a HTTP response. Therefore, since an operator of the web client machine 10 can display the previous portion or the next portion of the contents of the table on the web page by clicking the “back” button or the “next” button, the table on a web page seems to the operator to be scrolling as shown in FIG. 14.

According to the embodiment, the scroll display of a table functions because the extended tag (<uji:tableView -->) is contained in the text data 23 containing the script as mentioned above. The extended tag is constituted so as to execute the process to incorporate the information (<TABLE>--</TABLE>) for displaying a block that is a part of one table and the information (two <INPUT type=“submit”> tags) for displaying the “back” button and the “next” button as the input means about the blocks adjacent to the current block into the text (steps from S405 to S415 of FIG. 9). Therefore, a developer of web page data can easily design the function for switching the display of a block that is a part of one table by incorporating the extended tag into the text data 23. Moreover, a developer can easily create the text data about one web page that shows two or more tables at once by incorporating many extended tags in text data.

1. A table display switching method that is used in a computer network system in which a web server machine connected to a web client machine through a network creates web page data based on data in a file and transmits said web page data to said web client machine when said web server machine receives an HTTP request to specify the file from said web client machine, the method executed by said web server machine comprising:
creating web page data to which information for displaying one of blocks that are obtained by dividing a table and information for displaying an input means that is used to designate acquisition of said web page data containing information about blocks adjacent to the current block are incorporated according to extended description information when said data in the file designated by said web client machine at the time of receiving the HTTP request is text data including the extended description information for displaying a table;
transmitting a HTTP response including the created web page data to said web client machine that transmitted the request;
creating a web page in which information for displaying the adjacent blocks and information for displaying said input means about the blocks adjacent to the adjacent blocks according to the designation and the extended description information when the HTTP request including the designation is received from said web client machine to which the HTTP response was transmitted; and
transmitting the HTTP response including the created web page data to said web client machine that transmitted the request.

2. The table display switching method according to claim 1, wherein said data in the file designated by said web client machine through said HTTP request is text data that contains a server side script inside a text described in mark-up language.

3. The table display switching method according to claim 1 or 2, wherein said input means has an <INPUT> tag in HTML whose “type” attribute contains “submit”.

4. The table display switching method according to claim 3, wherein said input means has an <INPUT> tag in HTML whose “type” attribute contains “hidden”, and information about blocks adjacent to the displayed block is incorporated in a “name” attribute and a “value” attribute thereof.

5. The table display switching method according to claim 4, wherein said input means incorporates information about blocks adjacent to the displayed block in a “value” attribute of said <INPUT type=“hidden”> tag through the use of a JavaScript function.

6. A text data conversion program that runs on a computer connected to a web client machine through a network, said program comprising:
waiting until a HTTP request is transmitted from said web client machine;
determining whether the data in a file designated by said web client machine is text data including extended description information for displaying one table when the HTTP request is received;
incorporating information for displaying one of blocks that are obtained by dividing the table and information for displaying an input means that is used to designate acquisition of the text data containing information about blocks adjacent to the current block into the text data according to the extended description information when the data is text data including the extended description information;
transmitting a HTTP response whose body contains the text data incorporating the respective sets of information as web page data to said web client machine that transmitted the request;
waiting until a HTTP request containing the designation is transmitted from said web client machine to which the HTTP response was transmitted;
incorporating information for displaying the adjacent blocks and information for displaying said input means about blocks adjacent to the adjacent blocks according to the designation and the extended description information into the text data when the HTTP request is received; and
transmitting a HTTP response whose body contains the text data incorporating the respective sets of information as web page data to said client machine that transmitted the request.

7. The text data conversion program according to claim 6, wherein said computer is connected to a recording device that stores text data containing a server side script inside a text described in mark-up language, and text data containing extended description information for displaying a table is one of the text data stored in said recording device.

8. The text data conversion program according to claim 6 or 7, wherein said computer is operated to output an <INPUT> tag in HTML whose “type” attribute contains “submit” and an <INPUT> tag in HTML whose “type” attribute contains “hidden” into text data as said input means.

9. The text data conversion program according to claim 8, wherein said computer is operated to output a JavaScript function that incorporates information about blocks adjacent to the displayed block into the “value” attribute of said <INPUT type=“hidden ”> tag into said text data.

10. The text data conversion program according to claim 9, wherein said input means incorporates information about blocks adjacent to the displayed block into the “value” attribute of said <INPUT type=“hidden”> tag through the use of a JavaScript function.

11. A computer readable medium storing a text conversion program that runs on a computer connected to a web client machine through a network, said program comprising:
waiting until a HTTP request is transmitted from said web client machine;
determining whether the data in a file designated by said web client machine is text data including extended description information for displaying one table when the HTTP request is received;
incorporating information for displaying one of blocks that are obtained by dividing the table and information for displaying an input means that is used to designate acquisition of the text data containing information about blocks adjacent to the current block into the text data according to the extended description information when the data is text data including the extended description information;
transmitting a HTTP response whose body contains the text data incorporating the respective sets of information as web page data to said web client machine that transmitted the request;
waiting until a HTTP request containing the designation is transmitted from said web client machine that transmitted the HTTP response;
incorporating information for displaying the adjacent blocks and information for displaying said input means about blocks adjacent to the adjacent blocks according to the designation and the extended description information into the text data when the HTTP request is received; and
transmitting a HTTP response whose body contains the text data incorporating the respective sets of information as web page data to said client machine that transmitted the request.

12. A tag program that runs on a computer connected to a recording device that stores text data consists of many tags as a base of web page data and data to be described in a table on the web page, characterized in that said program outputs the information for displaying one of blocks that are obtained by dividing said table and the information for displaying an input means that is used to designate acquisition of the web page data containing information about blocks adjacent to the current block to the text data, when the specified tag as the extended description information is read during the respective tags in the text data are sequentially read.

13. A computer readable medium storing a tag program that runs on a computer connected to a recording device that stores text data consists of many tags as a base of web page data and data to be described in a table on the web page, characterized in that said program outputs the information for displaying one of blocks that are obtained by dividing said table and the information for displaying an input means that is used to designate acquisition of the web page data containing information about blocks adjacent to the current block to the text data, when the specified tag as the extended description informnation is read during the respective tags in the text data are sequentially read.
